(19) United States
(12) Patent Application Publication
(10) Pub. No.: US 2011/0221215 A1
(43) Pub. Date: Sep. 15, 2011

(54) METHODS AND APPARATUS FOR HANDLING A TOWER SECTION OF A WIND TURBINE WITH A CRANE

(75) Inventor: Adrian Botwright, Sabro (DK)

(73) Assignee: VESTAS WIND SYSTEMS A/S, Randers SV (DK)

(21) Appl. No.: 12/723,154

(22) Filed: Mar. 12, 2010

(51) Int. Cl. B66C 13/08; B66C 1/10; B66C 13/04

(52) U.S. Cl. 294/81.4

(57) ABSTRACT

Methods and apparatus for handling and maneuvering a tower section of a wind turbine with a crane. First and second lifting locations on the tower section are respectively connected with first and second sheave members on a beam coupled with a lifting mechanism of the crane. While the tower section is suspended from the beam at the first and second lifting locations, the tower section is rotated about an axis of rotation associated with the second sheave member to change its angular orientation. In response to rotation about the axis of rotation, the second sheave member is configured to move along the beam relative to the first sheave member so that the separation between the first and second sheave members is changed. Alternatively, a center of mass of the tower section may be moved relative to the beam in response to the rotation of the tower section.

### TECHNICAL FIELD

This application relates generally to methods and apparatus for handling a tower section of a wind turbine with a crane and, more specifically, to methods and apparatus for upending a tower section in a controlled manner with the assistance of a lifting beam.

### BACKGROUND

Wind turbines can be used to generate electrical energy without the need for fossil fuels. Generally, a wind turbine is a rotating machine to convert the kinetic energy of the wind into mechanical energy and, when used for power generation, to convert the mechanical energy to electrical power. A conventional horizontal-axis wind turbine includes a tower, a nacelle located at the apex of the tower, and a rotor that is supported in the nacelle by means of a shaft.

Although wind turbines have been in existence for centuries, the size and weight of contemporary wind turbines has dramatically increased. The tower of a contemporary wind turbine, which carries the nacelle and the rotor, may be manufactured in sections for ease of transport. Each tower section of a contemporary wind turbine may be 20 meters to 40 meters in length, up to 4 meters in diameter, and may weigh 30 to 80 metric tonnes. The tower weight generally scales upwardly with increasing installed power for the wind turbine because the supported structural load increases with increasing size of the nacelle and rotor. Consequently, future generations of wind turbines may incorporate even heavier and longer tower sections.

By necessity, moving wind turbine components from the factory floor to a project site involves transporting and handling multiple unwieldy components. In particular, the erection and assembly of the tower of a contemporary wind turbine is challenging because of the size and weight of the tower sections. For example, the tower sections may be transported with a horizontal orientation by ship to a quay or wharf, especially in a port city, and pre-assembled quayside to a vertical orientation. A pair of cranes is employed to offload the individual tower sections from the ship and to upright each tower section for pre-assembly. As another example, tower sections may also be upended at the project site after being transported with a horizontal orientation to the project site. Specifically, two cranes are used to upright or upend each tower section from a horizontal orientation to a vertical orientation so that the tower sections can be assembled at the project site.

The secondary crane, which is known in the art as a tailing crane, assists a primary crane in the upending operation to preassemble the tower sections. The primary crane is connected to the upper end of the tower section and the tailing crane is connected to the bottom end of the tower section. The primary crane supports the majority of the load presented by the tower section. While the primary crane lifts the tower section vertically by the upper end, the tailing crane prevents the bottom end from contacting the ground and retards the rotation rate as the orientation of the tower section changes from horizontal to vertical. When the upending operation is completed, the primary crane supports the tower section by one end and with a vertical orientation. Conventional upending operations are lacking because of the need for the tailing crane and the need for an auxiliary lifting operation that must be coordinated in time and space with the primary lifting operation. Conventional upending operations require manpower and expense for operating and coordinating the operation of the primary and tailing cranes.

Thus, while conventional upending techniques are generally successful for their intended purpose, there remains a need for improved methods and apparatus for upending a tower section of a wind turbine tower.

### SUMMARY

In an embodiment of the invention, a method is provided for handling a tower section of a wind turbine with a lifting apparatus coupled to a lifting mechanism of a crane. The lifting apparatus includes a beam, a first sheave member having a fixed position relative to the beam, and a second sheave member configured to move along the beam relative to the first sheave member. The method includes connecting the first and second sheave members with respective first and second lifting locations on the tower section, and lifting the tower section and the beam with the lifting mechanism of the crane such that the tower section is suspended from the beam at the first and second lifting locations. The method further includes, while the tower section is suspended, rotating the tower section about an axis of rotation associated with the second sheave member from a first angular orientation to a second angular orientation that differs from the first angular orientation. In response to rotating the tower section about the axis of rotation, the second sheave member may be moved along the beam relative to the first sheave member so that a separation between the first and second sheave members is changed. Alternatively, in response to rotating the tower section about the axis of rotation, a center of mass of the tower section may be shifted relative to the beam such that the beam remains approximately level.

In another embodiment of the invention, an apparatus is provided for handling a tower section of a wind turbine with a lifting mechanism of a crane. The apparatus includes a beam configured to be coupled with the lifting mechanism of the crane, a first sheave member supported by the beam in a fixed positional relationship with the beam and a second sheave member also supported by the beam. Each of the first and second sheave members includes a sheave. The second sheave member is movable along the beam relative to the first sheave member so as to vary a separation between the sheave of the first sheave member and the sheave of the second sheave member. The second sheave member is configured to be connected with the tower section at a first attachment location. The apparatus further includes a drive mechanism configured to move the second sheave member relative to the beam and to the first sheave member, a winch supported by the beam between the sheave of the first sheave member and the sheave of the second sheave member, and a cable extending from the winch to the second attachment location on the tower section. Between the winch and the second attachment location on the tower section, the cable is wound about the sheave of the first sheave member for a first change in direction relative to the beam and is wound about the sheave of the second sheave member for a second change in direction relative to the beam.

The tower section may be handled by a single crane, which eliminates the need for a second crane to facilitate the upending of the tower section. The beam is kept in a substantially level orientation as the tower section is upended. In one usage, a tower section may be offloaded from a ship and uprighted for pre-assembly quayside in a unified operation. In addition, the apparatus and methods of the embodiments of the invention may be used for large developments, such as an on-shore or off-shore wind farm, with a large number of tower sections to be upended.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a perspective view of a wind turbine;

FIG. 2 is a perspective view of a crane being used to upend a tower section of a wind turbine in accordance with an embodiment of the invention;

FIG. 3 is a side elevation view of the lifting apparatus that is suspended from the jib block of the crane of FIG. 2 and in which the tower section is suspended in a horizontal orientation from a beam of the lifting apparatus;

FIG. 4 is an end view from a perspective normal to one end of the beam of the lifting apparatus of FIG. 3 and a base of the tower section suspended from the lifting apparatus;

FIG. 5 is an end view from a perspective normal to an opposite end of the beam of the lifting apparatus of FIG. 3 and an upper end of the tower section suspended from the lifting apparatus;

FIG. 6 is a side elevation view similar to FIG. 3 that illustrates the change in orientation of the tower section during an upending operation;

FIG. 7 is another side elevation view similar to FIG. 3 that shows the lifting apparatus supporting the tower section in a vertical orientation from the beam; and

FIG. 8 is side elevation view similar to FIG. 3 of a lifting apparatus in accordance with an alternative embodiment of the invention.

### DETAILED DESCRIPTION

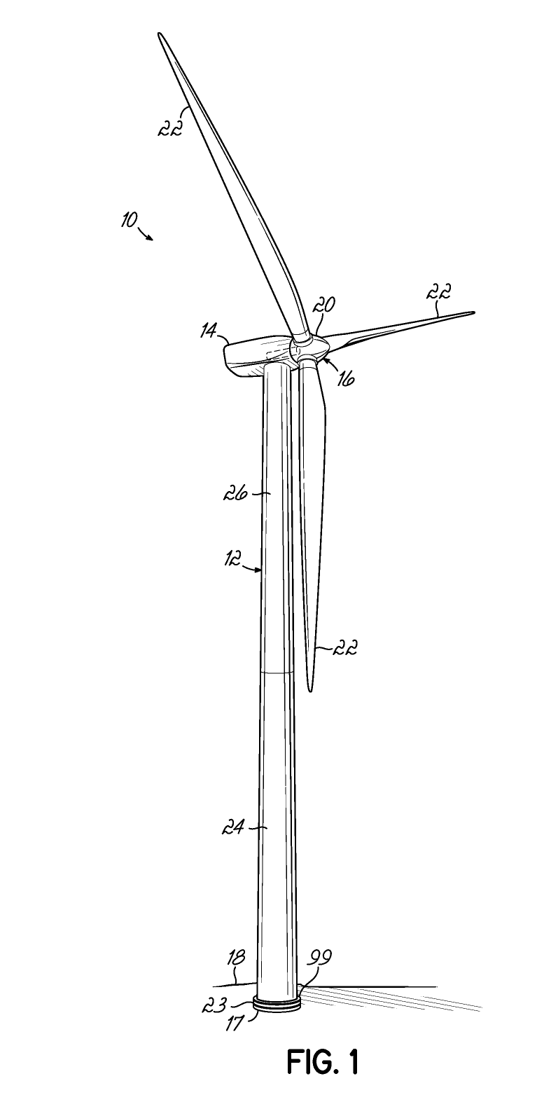

With reference to FIG. 1 and in accordance with an embodiment of the invention, a horizontal-axis wind turbine 10 has the capability of converting the kinetic energy of the wind into electrical energy. The wind turbine 10 includes a tower 12, a nacelle 14 at the apex of the tower 12, and a rotor 16 operatively coupled by a shaft to the nacelle 14. The tower 12 is configured as a generally elongated structure supported by and extending upwardly from a foundation 17 on a surface 18. The tower 12 operates to elevate the nacelle 14 and rotor 16 to a height above surface 18 at which faster moving air characterized by smoother and less turbulent air currents is typically found.

The nacelle 14 houses various components needed to convert the wind energy into electrical energy and also needed to operate and optimize the performance of the wind turbine 10. The rotor 16 includes a central hub 20 and a plurality of blades 22 attached to the central hub 20 at locations distributed about the circumference of the central hub 20. The blades 22, which extend radially outward from the central hub 20, are configured to interact with the passing air to produce lift that causes the central hub 20 to spin about its longitudinal axis. The central hub 20 of the rotor 16 is coupled by a gear box (not shown) with a generator (also not shown) housed inside the nacelle 14. The gearbox adapts the output of the rotor 16 to the generator for the conversion of wind energy into electrical energy. Specifically, the gearbox relies on gear ratios to provide speed and torque conversions from the rotation of the rotor 16 to the generator.

The tower 12 includes a plurality of tower sections 24, 26 that are stacked with an end-to-end, vertical arrangement. In the representative embodiment, the tower 12 includes a base tower section 24 and an upper tower section 26 stacked on the base tower section 24, although the invention is not so limited as the tower 12 may be segmented into more than two individual sections. When assembled, the upper tower section 26 is the section farthest removed from the surface 18 and the base tower section 24 is the section that is supported by the foundation 17 on surface 18. The tower sections 24, 26 may be secured together in the stacked arrangement by welding, bolted connections, and/or other known mechanical fastening assemblies. The tower 12 supports the load presented by the nacelle 14, rotors 16, and other wind turbine components housed inside the nacelle 14.

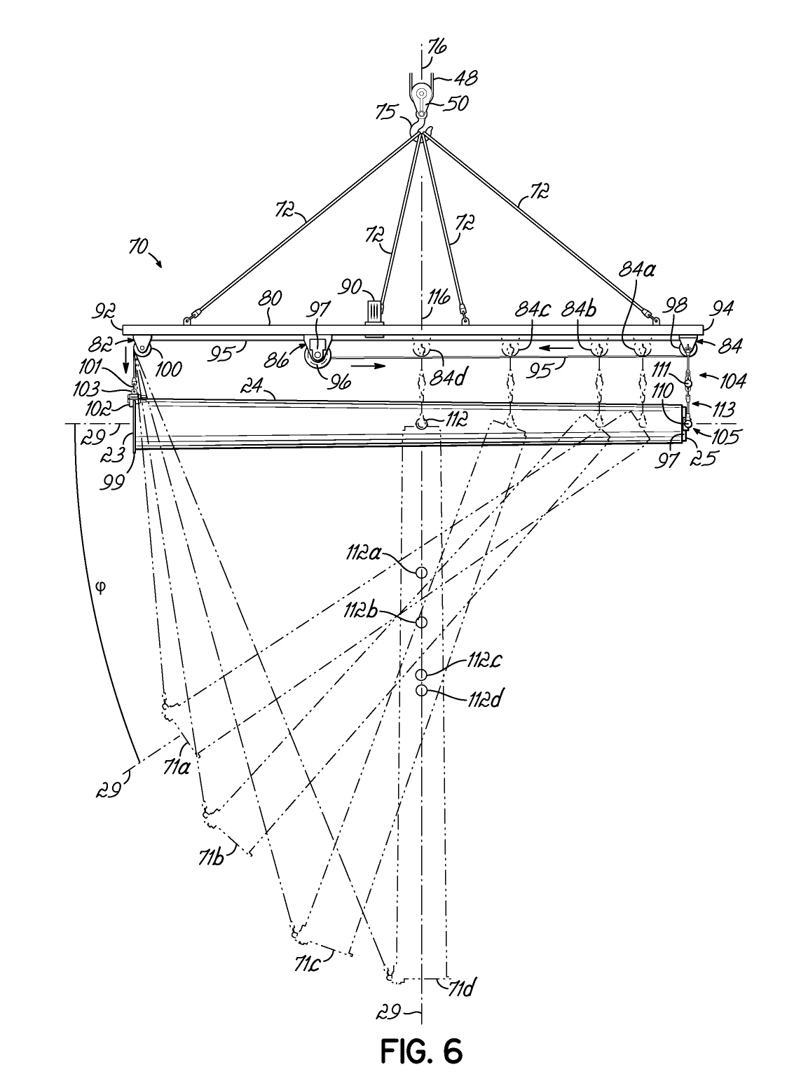

Each of the tower sections 24, 26 may be formed from lengths of tubular steel, although the construction material and cross-sectional shape are not so limited. As a result of the tubular construction, the tower 12 contains an internal cavity extending longitudinally within tower 12 from the foundation up to the nacelle 14. Each of the tower sections 24, 26 includes opposite open ends and is arranged along a longitudinal axis. For example, tower section 24 includes a bottom end or base 23, a top or upper end 25 opposite to the base 23, and a longitudinal axis 29 (FIG. 6) extending along the tower section 24 between the base 23 and upper end 25. Each of the tower sections 24, 26 may narrow in cross-sectional area along its length. For example, each of the tower sections 24, 26 may have a frustoconical geometrical shape with the diameter of each truncated cone narrowing in a lengthwise manner along the respective longitudinal axis. For example, the cross-sectional area of tower section 24 may continuously narrow from base 23 to the upper end 25. The tower sections 24, 26 are diametrically matched so that, when the tower 12 is erected, the diameter or transverse cross-sectional dimension of the tower 12 decreases with increasing separation from the surface 18.

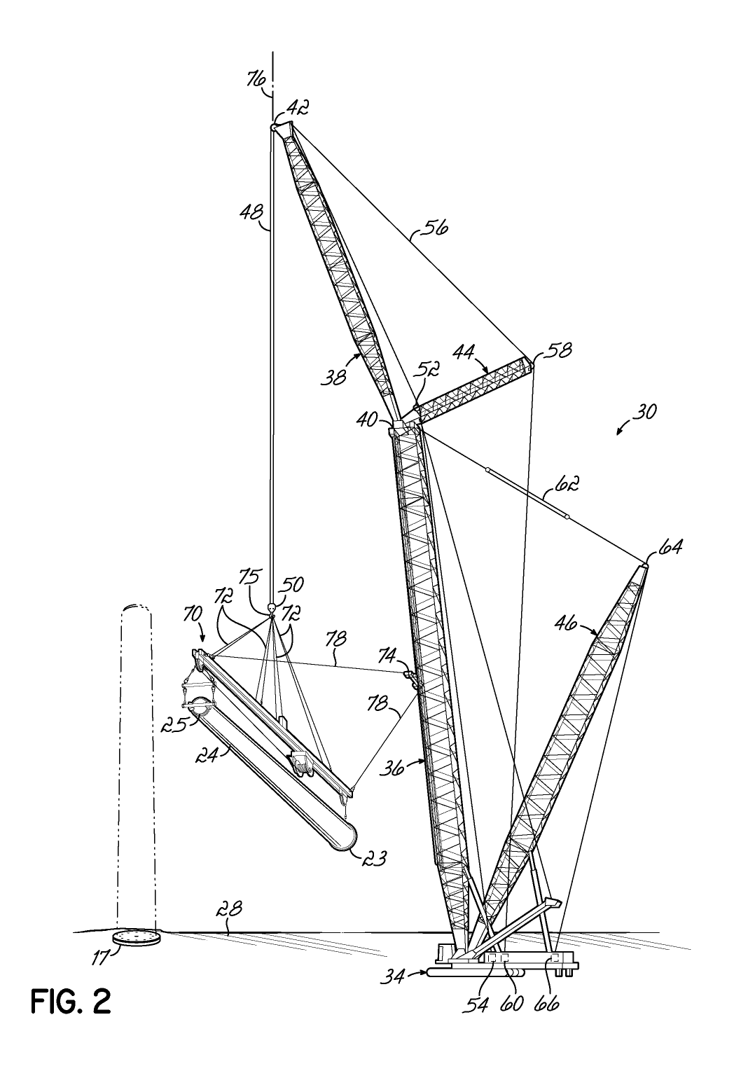

With reference to FIG. 2, a crane 30 is capable of raising a heavy object and maneuvering the heavy object into a desired location. In the representative embodiment, the crane 30 is used to upright or upend one or both of the tower sections 24, 26 during an assembly operation at a construction site of the tower 12 (FIG. 1) or a pre-assembly operation conducted at a location other than the tower construction site. In FIG. 2, the crane 30 is depicted at an initial stage of a process (FIG. 6) that is upending or uprighting tower section 24. After the orientation is changed from horizontal to vertical, the upended or uprighted tower section 24 is ultimately vertically disposed on a surface 28, which may be, for example, quayside if the tower section 24 is being unloaded from a shipping vessel, or may be surface 18 (FIG. 1).

The crane 30 includes a base 34 that is supported on the surface 28, which may be the ground, a platform, etc. A main boom 36 is movably coupled to base 34 at a first, lower end thereof and may have, for example, a generally latticed structure as is conventional in the art. A jib boom 38 has a first end that is movably coupled to the second, upper end of the main boom 36, such as at boom point 40. The second end of jib boom 38 includes a main sheave 42 rotatably coupled thereto for receiving the crane's rigging, as will be discussed below. A jib mast 44 may be pivotally coupled to the main boom 36 at boom point 40 and a gantry 46 may also be movably coupled to base 34, the purpose of each being explained below.

The rigging for crane 30 includes a main load bearing cable 48 for supporting and hoisting the tower sections 24, 26, in this instance the lower tower section 24. One end of the main load bearing cable 48 is connected to the jib boom 38. The other end of the main load bearing cable 48 is trained (i.e., routed or guided) through a sheave on a jib block 50, over the main sheave 42 on the second end of jib boom 38, over a second sheave 52 rotatably mounted on the jib mast 44, and connected to a main winch 54 supported on base 34. The sheave on jib block 50 and the main sheave 42 may include multiple grooved rims so that the main load bearing cable 48 is wrapped multiple times above each of these sheaves. The load presented by tower section 24 is directed along a line of action related to the main load bearing cable 48 and directed along a longitudinal axis 76. Because the main load bearing cable 48 may be wrapped multiple times about the sheaves of the jib block 50 and the main sheave 42, the longitudinal axis 76 does not have to be collinear with the cable 48 but may instead be displaced laterally from, and aligned parallel with, the main load bearing cable 48.

The rigging also includes a pendant cable 56 having one end connected to the jib boom 38, such as adjacent a second end thereof, and trained over a third sheave 58 rotatably mounted on the jib mast 44, and to a second winch 60 capable of reeling in and paying out pendant cable 56 in a controllable manner to move or adjust the angle of the jib boom 38. The rigging may further include a reeving 62 having an end connected to the main boom 36, such as adjacent a second end thereof, and trained over a fourth sheaving 64 on the gantry 46, and to a third winch 66 for reeling in and paying out reeving 62 in a controllable manner to move or adjust the angle of the main boom 36.

Those of ordinary skill in the art will recognize that all of the above-described components of crane 30 are generally well known in the art and have been described herein to provide a complete description and understanding of aspects and features to be described below. Moreover, the description of crane 30 provided above is exemplary and those of ordinary skill in the art will recognize that the lifting apparatus 70 described below may be used on a wide range of cranes, and is therefore not limited to the exemplary embodiment described herein.

A lifting apparatus, generally indicated by reference number 70, is secured by a plurality of cables 72 to the jib block 50. As best shown in FIG. 2, the cables 72 are coupled with a hook 75 of the jib block 50 such that the lifting apparatus 70 is suspended on the hook 75 from the main load bearing cable 48. The winch 54 constitutes a lifting apparatus capable of reeling in and paying out the main load bearing cable 48 in a controllable manner to raise and lower the tower section 24 supported from the lifting apparatus 70. The hook 75 may be configured to pivot relative to the remainder of the jib block 50 and may include a latch or another conventional like structure. A control mechanism 74 may be used to control the rotational attitude of the lifting apparatus 70. A cable 78 extends from the control mechanism 74 to spaced-apart attachment points on the lifting apparatus 70. In the representative embodiment, the attachment points on the lifting apparatus 70 are symmetrically located.

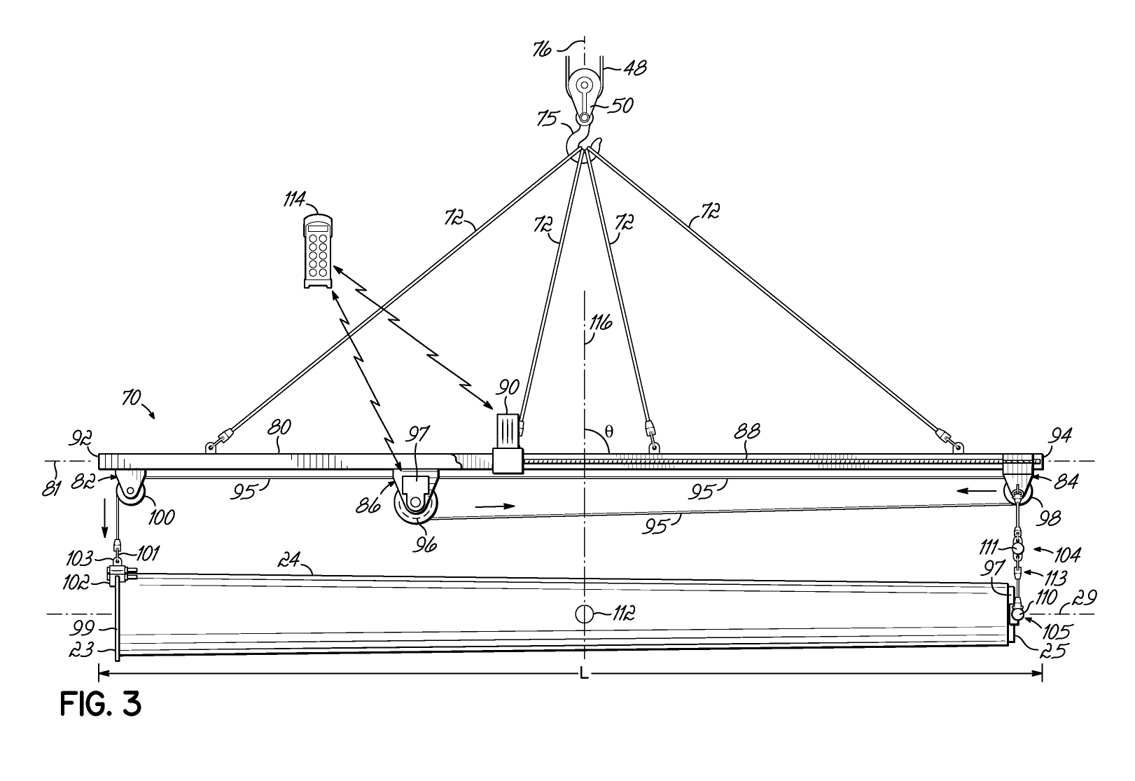

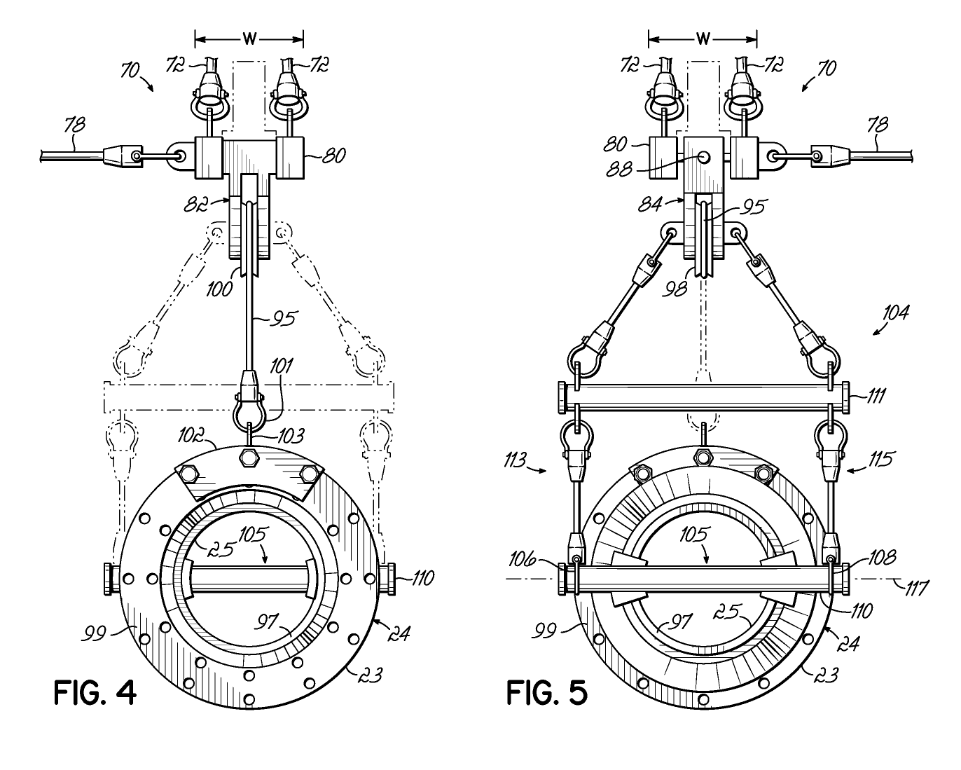

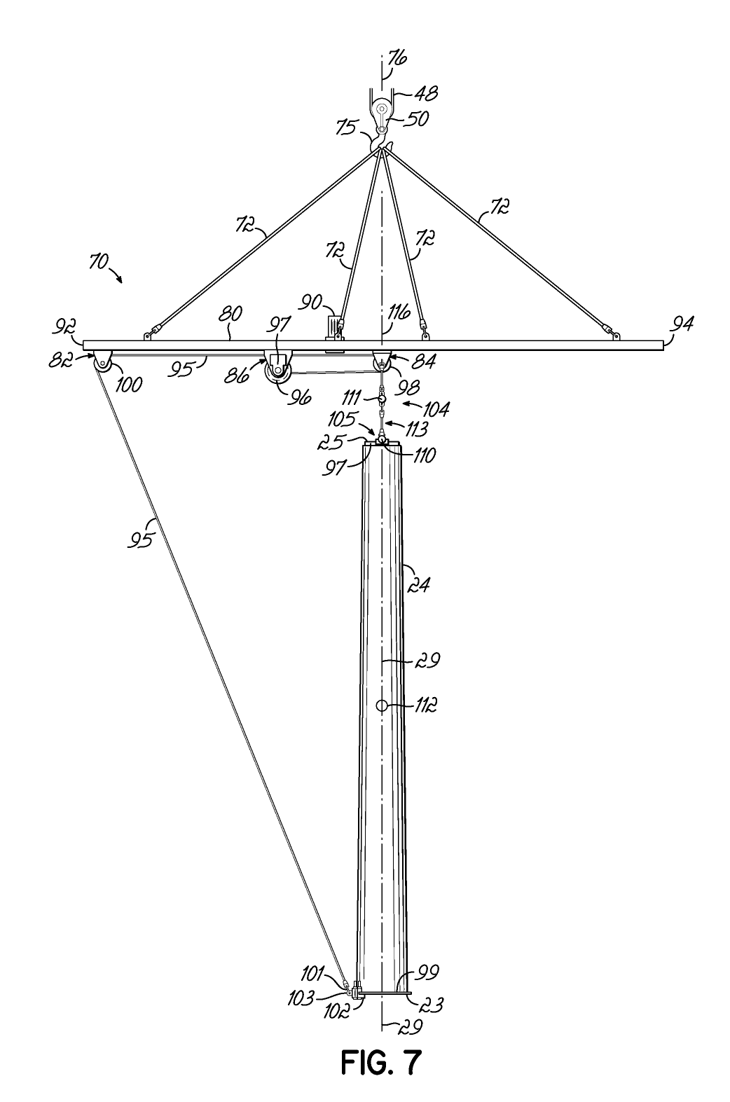

With reference to FIGS. 3-7, the lifting apparatus 70 includes a beam 80, a fixed block or sheave member 82, a traveling block or sheave member 84, a winch 86, a drive mechanism 90, and a lead screw 88 coupling the drive mechanism 90 with the traveling sheave member 84. During an upending operation, the traveling sheave member 84 is configured to be dynamically moved laterally relative to the beam 80 by the lead screw 88 and drive mechanism 90, while the fixed sheave member 82 remains stationary or static relative to the beam 80. Specifically, the traveling sheave member 84 is configured to move toward the fixed sheave member 82 as the tower section 24 is pivoted from a horizontal orientation (FIG. 3) to a vertical orientation (FIG. 7). The location of the fixed sheave member 82 relative to the length of the beam 80 is representative as the fixed sheave member 82 may have any suitable position so long as the winch 86 is located between the fixed and traveling sheave members 82, 84 and the upending operation remains feasible. For example, the fixed sheave member 82 may be suitably positioned depending on the length of the tower section being lifted.

The beam 80 is an elongate, rail-shaped member extending along a longitudinal axis 81 from a first terminal end 92 to a second terminal end 94. The beam 80 has a major dimension along its length, L, and a minor dimension along its width, W, such that the beam 80 is significantly longer than it is wide. The cables 72 coupling the beam 80 to the hook 75 of the jib block 50 are engaged with respective flanges distributed along the major dimension (i.e., length) of the beam 80. The traveling sheave member 84 is supported by the beam 80 in a movable manner, such as upon guided rollers. The fixed sheave member 82 has a fixed positional relationship with the beam 80 and is secured thereto in a conventional manner to establish the characteristic fixed position.

The winch 86 is centrally situated between the opposite first and second ends 92, 94 of the beam 80 and is disposed between the fixed sheave member 82 and the traveling sheave member 84. The winch 86 includes a spool or winch drum 96 configured for bidirectional rotation by, for example, an electric winch motor 97. A wire rope or cable 95 has one end that is wound about the winch drum 96. When the winch drum 96 is driven by the winch motor 97 and contingent on the rotational direction, the winch 86 is configured to pull in (wind up) or let out (wind out) the cable 95. The winch 86 may include an electrical brake (not shown) that is powered brake off to prevent rotation of the winch drum 96 when the winch motor 97 is not energized.

The traveling sheave member 84 includes a pulley or sheave 98 supported on a pin or axle defining a rotation axis spanning between a pair of side supports. The fixed sheave member 82 likewise includes a pulley or sheave 100 supported on another pin or axle defining a rotation axis spanning between a pair of side supports. Each of the sheaves 98, 100 is characterized by a wheel or roller with a grooved rim for holding the cable 95. The cable 95 is serially wound about the sheave 98 of the traveling sheave member 84 and then the sheave 100 of the fixed sheave member 82. The cable 95 from the winch 86 extends along the underside of the beam 80 and is reeved around the sheave 98 of the traveling sheave member 84. The sheave 98 of the traveling sheave member 84 reverses the direction of the cable 95 so that the cable 95 extends along the underside of the beam 80 to the sheave 100 of the fixed sheave member 82. The direction of the force applied to the cable 95 changes at each of the sheaves 98, 100. Specifically, the direction of the force applied to the cable 95 changes by about 180° at sheave 98 and changes by about 90° at sheave 100.

The cable 95 is fastened by wrapping around (i.e., reeved about) the sheave 100 of the fixed sheave member 82 and extends downwardly from the fixed sheave member 82 to a connecting bracket 102. The connecting bracket 102 is attached with conventional fasteners to a peripheral flange 99 on the base 23 of tower section 24. The end of the cable 95 is secured by a conventional shackle 101 to a flange 103 projecting from the connecting bracket 102. When the winch 86 is actuated to pull in or let out the cable 95, the cable 95 is selectively fed or retracted and, in response, the connecting bracket 102 is either raised or lowered relative to the beam 80. The cable 95 directly supports a portion of the rigid load presented by the tower section 24 at the representative lifting location defined at the base 23 of the tower section 24. A tensile force is created in the cable 95 by the load.

A double sling, generally indicated by reference numeral 104, directly connects the traveling sheave member 84 with a flange 99 on the upper end 25 of the tower section 24. The double sling 104 spans the gap between the traveling sheave member 84 and flange 99 at the upper end 25 of the tower section 24. The double sling 104 is connected to a connecting bracket 105 that includes a pin or shaft 110 that is attached in a conventional manner to the upper end 25 of tower section 24 and trunnions 106, 108 mounted on the shaft 110. The shaft 110 is roughly positioned across the diameter of the upper end 25 of tower section 24. Another pin or shaft 111 operates to spread the two legs 113, 115 of the double sling 104 in a spaced apart relationship. Each of the legs 113, 115 is segmented with shackled attachments to the shaft 111. The legs 113, 115 of the double sling 104 are free to rotate on the trunnions 106, 108 about a longitudinal axis 117 of the shaft 110, which defines the axis of rotation for the tower section 24 during the upending operation. This degree of rotational freedom permits the upper end 25 of the tower section 24 to pivot or rotate relative to the double sling 104 and beam 80 as the position of the traveling sheave member 84 changes along the length of the beam 80. The traveling sheave member 84 directly supports a portion of the rigid load presented by the tower section 24 at the representative lifting location defined at the upper end 25 of the tower section 24. In alternative embodiments, the lifting locations on the tower section 24 may differ from adjacent to the base 23 and the upper end 25.

In contrast to the varying length of cable 95 that is dictated by the operation of the winch 86, the length of the legs 113, 115 of the double sling 104 is fixed. As a result, the distance from the shaft 110 to the beam 80 of the lifting apparatus 70 remains fixed and invariable as the traveling sheave member 84 is moved relative to the beam 80. The double sling 104 directly supports a portion of the rigid load presented by the tower section 24. A tensile force is developed in the legs 113, 115 of the double sling 104 by the load.

The driven lead screw 88 is configured to move the traveling sheave member 84 in a controlled manner laterally along a portion of the length of the beam 80. To that end, the drive mechanism 90 drives the rotation of the lead screw 88 to move the traveling sheave member 84 and thereby decrease the separation between the fixed sheave member 82 and traveling sheave member 84. Conversely, the drive mechanism 90 is reversible to increase this separation between members 82, 84. The lead screw 88 is designed to translate rotary motion of the lead screw 88 into linear motion of the traveling sheave member 84 relative to the beam 80. The traveling sheave member 84 is secured with the threads of the lead screw 88 in a conventional manner. When the drive mechanism 90 is unpowered, the lead screw 88 holds the traveling sheave member 84 immobile. The motion of the traveling sheave member 84 is synchronized with the operation of the winch 86 to lengthen the cable 95 during the operation upending the tower section 24 supported by the beam 80.

The tower section 24 has a center of gravity 112, which is used synonymously herein with the term center of mass, representing the point at which the entire mass of tower section 24 can be considered to be concentrated for the purpose of calculations. In terms of moments, the center of gravity 112 of the tower section 24 is the point around which the moments of the gravitational forces completely cancel one another. Because the tower section 24 is a rigid body, the position of the center of gravity 112 is fixed in space and time in relation to the tower section 24.

A reference line 116 can be defined in relation to the beam 80 of the lifting apparatus 70. In various embodiments, the reference line 116 may extend through a geometrical center of the beam 80, may be offset laterally from the geometrical center, may extend through a center of gravity of the lifting apparatus 70, may be offset laterally from the center of gravity of the lifting apparatus 70. The reference line 116 may be generally collinear with the longitudinal axis 76 of the main load bearing cable 48 and may be considered to remain static during the upending operation. Preferably, the beam 80 has an approximately level or horizontal attitude with the load presented by the tower section 24 equally balanced relative to the reference line.

In use, the connecting bracket 102 is attached to the base 23 of tower section 24 and the double sling 104 is attached to the upper end 25 of tower section 24. The tower section 24 is hoisted or lifted by the crane 30, for example, quayside from the deck of a ship. The mass of the suspended tower section 24 is supported by the main load bearing cable 48 from the lifting apparatus 70 in a first angular orientation, which may be substantially horizontal or level orientation. In one embodiment, the longitudinal axis 81 of beam 80 may be aligned parallel with the longitudinal axis 29 of the tower section 24 when the tower section 24 is considered horizontal or level.

While the tower section 24 is suspended above the surface 28, the traveling sheave member 84 and the upper end 25 of tower section 24 are moved laterally relative to the beam 80 toward the location of the reference line 116 and toward the fixed sheave member 82 while paying out the cable 95 from the winch 86. A series of locations for the traveling sheave member 84 are indicated diagrammatically by reference numerals 84a-d on FIG. 6. Under the influence of gravity, the tower section 24 rotates about the longitudinal axis 117 of the shaft 110 as the base 23 of tower section 24 moves downwardly away from the beam 80. As a result of the motion of the traveling sheave member 84, the base 23 of the tower section 24 is lowered toward surface 28 and the upper end 25 is moved away from the end 94 of beam 80 toward the center of the beam 80 (i.e., toward reference line 116). The progression of positions 71a-d of different angular orientation for tower section 24, which is correlated with the series of different positions 84a-d for the traveling sheave member 84, is shown in FIG. 6. As the tower section 24 rotates toward the upended position of FIG. 7, the portion of the weight supported from the traveling sheave member 84 incrementally increases and the portion of the weight supported from the fixed sheave member 82 incrementally decreases in proportion to the angular orientation as verticality is approached.

After rotation is completed, the tower section 24 is oriented vertically or upright (FIG. 7) and the base 23 of the tower section 24 is not in contact with the underlying surface 28. In the vertical orientation, the longitudinal axis 29 of the tower section 24 is approximately aligned with the longitudinal axis 76 of the main load bearing cable 48 and with reference line 116, and the vector for the load presented by the tower section 24 is directed along reference line 116. While maintained in the vertical orientation, the crane 30 can lower the tower section 24 until the end 23 contacts the surface 28. After the tower section 24 is released from the lifting apparatus 70, the tower section 24 may be freestanding vertical or may be secured with foundation 17 or another temporary fixture to maintain the verticality.

As the tower section 24 is rotated from the angular orientation of FIG. 3 to the angular orientation of FIG. 7, the traveling sheave member 84 and winch 86 are controlled such that an inclination angle, θ, between the longitudinal axis 81 of the beam 80 and the reference line 116 substantially constant. In the representative embodiment, the inclination angle, θ, is maintained at about 90° so that the beam 80 stays essentially horizontal relative to a reference plane or level. When horizontal, the longitudinal axis 29 of the tower section 24 may be aligned parallel with the longitudinal axis 81 of beam 80.

The portion of the mass of the tower section 24 supported by the traveling sheave member 84 represents a force that acts on the beam 80 with a moment arm relative to, for example, the reference line 116. Similarly, the portion of the mass of the tower section 24 supported by the fixed sheave member 82 represents a force that acts on the beam 80 with a moment arm that can be measured relative to the reference line 116. The product of each force and its respective moment arm gives rise to a moment of each force. When the tower section 24 is horizontally supported from the beam 80 and static, the moments acting on the beam 80 are equal in magnitude and opposite in sign (i.e., in equilibrium as the vector sum of the forces is zero). As the tower section 24 is rotated about the longitudinal axis 117 of shaft 110 by paying out cable 95 from winch 86, the tower section 24 rotates about the longitudinal axis 117 through the continuous progression of angular orientations, as diagrammatically indicated by reference numerals 71a-d in FIG. 6. At each of the angular orientations, the longitudinal axis 29 of the tower section 26 has a unique inclination angle, φ, measured relative to the initial horizontal position. The motion of the traveling sheave member 84 inwardly toward the winch 86 closes the distance between the fixed and traveling sheave members 82, 84 and reduces the distance from the traveling sheave member 82 to the reference line 116 and to the winch 86. The result is that the force acting on the beam 80 at the location of the traveling sheave member 84 increases as the tower section 24 rotates and the force acting on the beam 80 at the location of the fixed sheave member 82 decreases.

The inward motion of the traveling sheave member 84 compensates for the re-allocation of the magnitudes of the forces acting on the beam 80 by changing the moment arm for the force acting on the traveling sheave member 84. This maintains the moments of the forces acting on beam 80 in equilibrium so that the beam 80 does not rotate in conjunction with the rotation of the tower section 24 about the longitudinal axis 117 associated with the traveling sheave member 84. In other words, the angular inclination of the beam 80 remains unchanged and level. When the tower section 24 is vertically aligned (i.e., φ=90°), the traveling sheave member 84 is aligned with the longitudinal axis 76 of the main load bearing cable 48 so that the magnitude of force acting on the fixed sheave member 82 is zero and the magnitude of the force acting on the traveling sheave member 84 is equal to the weight of the tower section 24. When vertical, the longitudinal axis 29 of the tower section 24 may be aligned perpendicular to the longitudinal axis 81 of beam 80 and may be aligned parallel with the reference line 116 and/or the longitudinal axis 76 of the main load bearing cable 48.

As the tower section 24 is rotated about the longitudinal axis 117 through the continuous progression of angular orientations, (FIG. 6) from the angular orientation of FIG. 3 to the angular orientation of FIG. 7, the traveling sheave member 84 and winch 86 are controlled such that the position of the center of gravity 112 of the tower section 24 is controlled as the tower section 24 is upended. The location of the center of gravity 112 at the different angular orientations 71a-d is indicated by the series of reference numerals 112a-d on FIG. 6 and is correlated with the series of different positions 84a-d for the traveling sheave member 84. Specifically, the center of gravity 112 of the tower section 24 remains approximately aligned with the reference line 116 of the beam 80 and moves away from the beam 80 toward the surface 28. In one embodiment, the linear path of the center of gravity is approximately collinear with the axis 76 of the main load bearing cable 48 connecting the lifting mechanism of the crane 30 with the beam 80.

In the representative embodiment, the winch motor 97 of the winch 86 and the drive mechanism 90 moving the lead screw 88 coupled with the traveling sheave member 84 are controlled with the use of a radio remote 114. In other words, an operator (e.g., the operator of crane 30) may observe the uprighting operation and, based upon visual queues, control the winch motor 97 of winch 86 and drive mechanism 90 for the lead screw 88 so that the beam 80 remains level because of the balanced moments and the location of the center of gravity 112 of the tower section 24 is constrained to trace an approximately linear path in space and time. The constraint is imposed by matching the paying out of the cable 95, which causes the tower section 24 to pivot about longitudinal axis 117, and the lateral motion of the traveling sheave member 84, which coordinates the movement of the center of gravity 112. The radio remote 114 includes a transceiver (not shown) that communicates with a transceiver (not shown) at the winch motor 97 and with a transceiver (not shown) at the drive mechanism 90 for the lead screw 88. The angular rotation of the tower section 24 is controlled by the operator using the radio remote 114 such that the beam 80 remains level with a substantially constant inclination angle, θ.

Of course, the reverse operation may be performed to rotate the tower section 24 from a vertical orientation to a horizontal orientation. In this instance, the traveling sheave member 84 and the upper end 25 of the tower section 24 will move laterally relative to the beam 80 away from the center of the beam 80 as the tower section 24 is rotated, and the center of mass 112 would move along a linear path toward the beam 80.

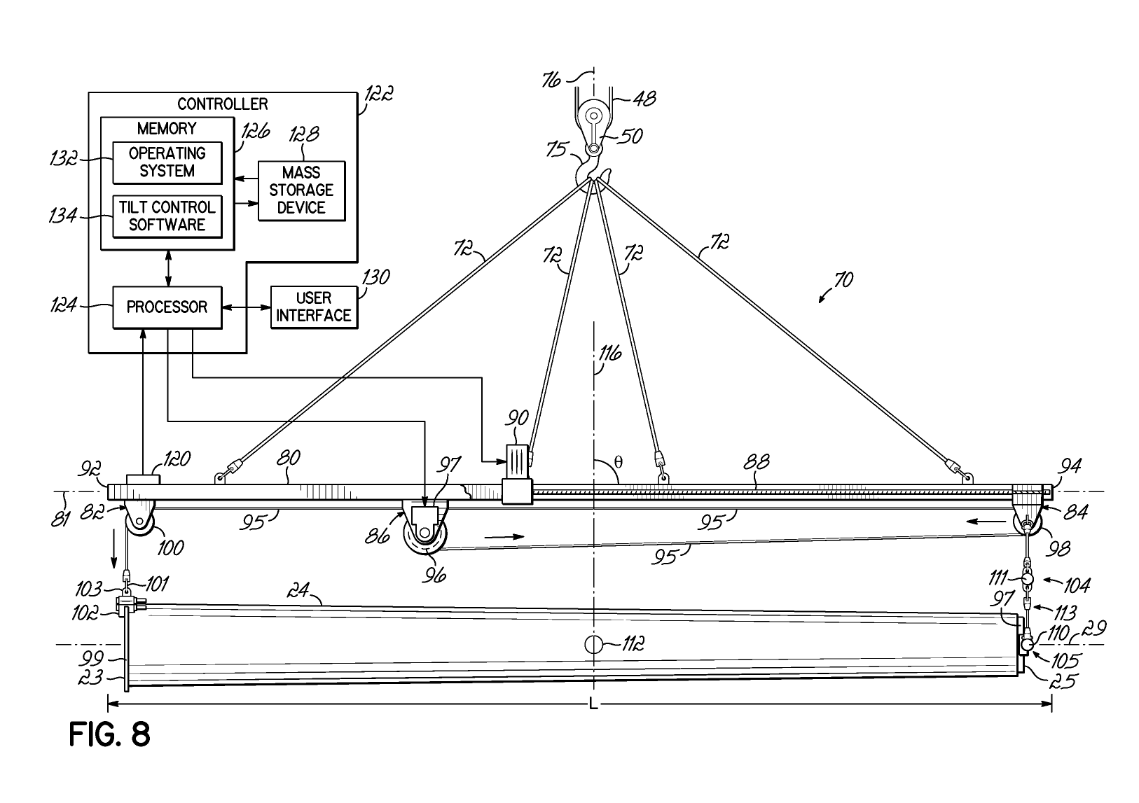

With reference to FIG. 8 and in accordance with an alternative embodiment of the invention, a tilt sensor or inclinometer 120 is placed on the beam 80 of the lifting apparatus 70 and is coupled in communication with a controller 122. The controller 122 may represent any computer, computer system, or programmable device recognized by a person having ordinary skill in the art and capable of carrying out the functions described herein, as will be understood by those of ordinary skill in the art. Controller 122 typically includes at least one processor 124 coupled to a memory 126. Processor 124 may represent one or more processors (e.g., microprocessors), and memory 126 may represent the random access memory (RAM) devices comprising the main storage of the controller 122, as well as any supplemental levels of memory, e.g., cache memories, non-volatile or backup memories (e.g. programmable or flash memories), read-only memories, etc. In addition, memory 126 may be considered to include memory storage physically located elsewhere in controller 122, e.g., any cache memory in processor 124, as well as any storage capacity used as a virtual memory, e.g., as stored on a mass storage device 128 or another computer (not shown) coupled to controller 122 via a network.

The controller 122 is coupled with a user interface 130 configured to receive a number of inputs and outputs for communicating information externally. For interaction with a user or operator, the user interface 130 typically includes one or more user input devices (e.g., a keyboard, a mouse, a trackball, a joystick, a touchpad, a keypad, a stylus, and/or a microphone, among others) and a display (e.g., a CRT monitor or an LCD display panel, among others).

Controller 122 operates under the control of an operating system 132, and executes or otherwise relies upon various computer software applications, components, programs, objects, modules, data structures, etc. In general, the routines executed by the controller 122 to operate the lifting apparatus 70, whether implemented as part of an operating system or a specific application, component, program, object, module or sequence of instructions will be referred to herein as “computer program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention.

The controller 122 includes digital and/or analog circuitry that interfaces the processor 124 with the winch motor 97 for the winch drum 96 of the winch 86 and that also interfaces with the drive mechanism 90 moving the lead screw 88 for the traveling sheave member 84. Tilt control software 134 resides as an application in the memory 126 and is executed by the processor 124 in order to issue commands that control and coordinate the operation of the drive mechanism 90 and winch motor 97, as explained above.

As the tower section 24 is rotated relative to the beam 80, the inclinometer 120 monitors the tilt or inclination angle, θ, of the beam 80 and communicates signals to the controller 122. In response to these signals received from the inclinometer 120, the controller 122 is configured to operate the winch motor 97 of the winch 86 and the drive mechanism 90 to move the lead screw 88 coupled with the traveling sheave member 84 to compensate for any change or deviation in the inclination angle. Preferably, the inclination angle is controlled such that the beam 80 remains horizontal or level. Deviations in the inclination angle are detected by the inclinometer 120 and the controller 122 responds to automatically compensate for the deviations so that the moments of the forces acting on beam 80 are maintained in equilibrium so that the beam 80 does not rotate in conjunction with the rotation of the tower section 24 about the longitudinal axis 117 associated with the traveling sheave member 84.

The lifting apparatus 70 may provide various benefits and advantages in comparison with conventional apparatus. For example, the lifting apparatus 70 reduces the handling operations and eliminates the requirement for a tailing crane during the uprighting operation. In addition, fewer handling lifts are required.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “composed of”, or variants thereof are used in either the detailed description or the claims, such terms are intended to be inclusive in a manner similar to the term “comprising.”

While the invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicants' general inventive concept.

What is claimed is:

1. A method of handling a tower section of a wind turbine with a lifting apparatus coupled to a lifting mechanism of a crane, the lifting apparatus including a beam, a first sheave member having a fixed position relative to the beam, and a second sheave member configured to move along the beam relative to the first sheave member, the method comprising:
connecting the first sheave member with a first lifting location on the tower section;
connecting the second sheave member with a second lifting location on the tower section;
lifting the tower section and the beam with the lifting mechanism of the crane such that the tower section is suspended from the beam at the first and second lifting locations;
while the tower section is suspended, rotating the tower section about an axis of rotation associated with the second sheave member from a first angular orientation to a second angular orientation that differs from the first angular orientation; and
in response to rotating the tower section about the axis of rotation, moving the second sheave member along the beam relative to the first sheave member so that a separation between the first and second sheave members is changed.

2. The method of claim 1 wherein the beam has an inclination angle measured relative to a main load bearing cable connecting the lifting mechanism with the beam, and moving the second sheave member along the beam relative to the first sheave member to change the separation between the first and second sheave members comprises:
when the tower section is in the first angular orientation, determining the inclination angle of the beam; and
in response to the tower section rotating to the second angular orientation, maintaining the inclination angle of the beam substantially constant by movement of the second sheave member.

3. The method of claim 1 wherein the first angular orientation is approximately horizontal and the second angular orientation is approximately vertical such that the tower section is upended by the rotation about the axis of rotation.

4. The method of claim 1 further comprising:
in response to the second sheave member on the tower section moving along the beam relative to the first sheave member, monitoring an inclination angle of the beam to detect a change in the inclination angle.

5. The method of claim 4 wherein the inclination angle of the beam is sensed by a sensor, and moving the second sheave member along the beam relative to the first sheave member to change the separation between the first and second sheave members comprises:
communicating the inclination angle from the sensor to a controller; and
operating the controller to cause movement of the second sheave member.

6. The method of claim 1 wherein the beam includes a winch and a cable extending from the winch serially about a sheave of the first sheave member and about a sheave of the second sheave member to the first lifting location, and rotating the tower section about the axis of rotation associated with the first lifting location comprises:
operating the winch to change a length of the cable relative to the first sheave member so that the tower section rotates under the influence of gravity about the axis of rotation.

7. The method of claim 6 wherein the second sheave member is moved along the beam relative to the first sheave member in response to the operation of the winch.

8. The method of claim 1 wherein moving the second sheave member along the beam relative to the first sheave member to change the separation between the first and second sheave members comprises:
moving the second sheave member toward the first sheave member as the tower section rotates about the axis of rotation from the first angular orientation to the second angular orientation to upend the tower section.

9. A method of handling a tower section of a wind turbine with a lifting apparatus coupled to a lifting mechanism of a crane, the lifting apparatus including a beam, a first sheave member having a fixed position relative to the beam, and a second sheave member configured to move along the beam relative to the first sheave member, the method comprising:
connecting the first sheave member with a first lifting location on the tower section;
connecting the second sheave member with a second lifting location on the tower section;
lifting the tower section and the beam with the lifting mechanism of the crane such that the tower section is suspended from the beam at the first and second lifting locations;
while the tower section is suspended, rotating the tower section about an axis of rotation associated with the second sheave member from a first angular orientation to a second angular orientation that differs from the first angular orientation; and
in response to rotating the tower section about the axis of rotation, shifting a center of mass of the tower section relative to the beam such that the beam remains approximately level.

10. The method of claim 9 wherein the first angular orientation is approximately horizontal and the second angular orientation is approximately vertical such that the tower section is upended by the rotation about the axis of rotation.

11. The method of claim 9 wherein the beam includes a winch and a cable extending from the winch serially about a sheave of the first sheave member and about a sheave of the second sheave member to the first lifting location, and rotating the tower section about the axis of rotation associated with the first lifting location comprises:
operating the winch to change a length of the cable relative to the first sheave member so that the tower section rotates under the influence of gravity about the axis of rotation.

12. The method of claim 11 wherein shifting the center of mass of the tower section relative to the beam such that the beam remains approximately level comprises:
in response to operating the winch, moving the second sheave member along the beam relative to the first sheave member so that along the center of mass traces a linear path that is approximately collinear with an axis of a main load bearing cable connecting the lifting mechanism of the crane with the beam.

13. The method of claim 10 wherein shifting a center of mass of the tower section relative to the beam comprises:
moving the second sheave member along the beam relative to the first sheave member to change a separation between the first and second sheave members in coordination with the rotation of the tower section about the axis of rotation.

14. The method of claim 10 wherein shifting the center of mass of the tower section relative to the beam comprises:
moving the center of mass of the tower section along a linear path that is approximately collinear with an axis of a main load bearing cable connecting the lifting mechanism of the crane with the beam.

15. An apparatus for handling a tower section of a wind turbine with a lifting mechanism of a crane, the apparatus comprising:
a beam configured to be coupled with the lifting mechanism of the crane;
a first sheave member supported by the beam in a fixed positional relationship with the beam, the first sheave member including a sheave;
a second sheave member supported by the beam and including a sheave, the second sheave member movable along the beam relative to the first sheave member so as to vary a separation between the sheave of the first sheave member and the sheave of the second sheave member, and the second sheave member configured to be directly connected with the tower section at a first attachment location;
a drive mechanism configured to move the second sheave member relative to the beam and to the first sheave member;
a winch supported by the beam between the sheave of the first sheave member and the sheave of the second sheave member; and
a cable extending from the winch to the second attachment location on the tower section, the cable being wound about the sheave of the first sheave member for a first change in direction relative to the beam, and the cable being wound about the sheave of the second sheave member for a second change in direction relative to the beam.

16. The apparatus of claim 15 wherein the beam has a first end and a second end separated from the first end by a majority of the length of the beam, and the sheave of the second sheave member, the sheave of the second sheave member, and the winch are located between the first and second ends of the beam.

17. The apparatus of claim 15 further comprising:
a lead screw coupling the drive mechanism with the second sheave member, the drive mechanism configured to rotate the lead screw such that the second sheave member is moved in a linear path relative to the rail.

18. The apparatus of claim 17 further comprising:
a sensor configured to detect an inclination angle of the beam; and
a controller coupled in communication with the sensor and with the drive mechanism, the controller configured to respond to a change in the inclination angle by causing the drive mechanism to operate the lead screw and thereby move the second sheave member in the linear path.

19. The apparatus of claim 15 further comprising:
a connecting bracket coupling the second sheave member with the first attachment location on the tower section, the connecting bracket including an axis of rotation proximate to the first attachment location that permits the tower section to rotate relative to the second sheave member.

20. The apparatus of claim 15 further comprising:
a sensor configured to detect an inclination angle of the beam; and
a controller coupled in communication with the sensor and with the drive mechanism, the controller configured to respond to a change in the inclination angle by causing the drive mechanism to move the second sheave member relative to the beam.
